(19) United States
(12) Patent Application Publication
(10) Pub. No.: US 2024/0213467 A1
(43) Pub. Date: Jun. 27, 2024

(54) POSITIVE ELECTRODE ACTIVE MATERIAL FOR LITHIUM ION BATTERY, POSITIVE ELECTRODE MATERIAL, POSITIVE ELECTRODE, SOLID-STATE BATTERY, POSITIVE ELECTRODE ACTIVE MATERIAL FOR SODIUM ION BATTERY, AND METHOD OF PRODUCING POSITIVE ELECTRODE ACTIVE MATERIAL FOR LITHIUM ION BATTERY

(71) Applicant: TOYOTA JIDOSHA KABUSHIKI KAISHA, Toyota-shi (JP)

(72) Inventor: Issei SUGIYAMA, Susono-shi (JP)

(73) Assignee: TOYOTA JIDOSHA KABUSHIKI KAISHA, Toyota-shi (JP)

(21) Appl. No.: 18/386,065

(22) Filed: Nov. 1, 2023

(30) Foreign Application Priority Data
Dec. 26, 2022 (JP) 2022-209081

(51) Int. Cl. H01M 4/525; H01M 4/38; H01M 4/505; H01M 10/052

(52) U.S. Cl. CPC H01M 4/525; H01M 4/381; H01M 4/505; H01M 10/052; H01M 2004/028

(57) ABSTRACT

A positive electrode active material for a lithium ion battery includes a core portion having a crystalline structure with an O3 structure and a shell portion that covers the core portion and has at least one type of crystalline structure selected from the group consisting of an O2 structure, a T #2 structure, and an O6 structure.

### CROSS-REFERENCE TO RELATED APPLICATION

This application is based on and claims priority under 35 USC 119 from Japanese Patent Application No. 2022-209081 filed on Dec. 26, 2022, the disclosure of which is incorporated by reference herein.

### BACKGROUND

### Technical Field

The present disclosure relates to a positive electrode active material for a lithium ion battery, a positive electrode material, a positive electrode, a solid-state battery, a positive electrode active material for a sodium ion battery, and a method of producing a positive electrode active material for a lithium ion battery.

### Related Art

A positive electrode active material having at least one type of crystalline structure selected from the group consisting of an O2 structure, a T #2 structure, and an O6 structure is stable up to a high electric potential, and thus has a large charge/discharge capacity when it is charged/discharged in an electric potential region including a high electric potential region.

Japanese Patent Application Laid-open (JP-A) No. 2014-186937 proposes a positive electrode active material for use in a non-aqueous electrolyte secondary battery, wherein the positive electrode active material has a layered structure and includes a lithium-containing transition metal oxide in which a main arrangement of a transition metal, oxygen, and lithium is represented by an O2 structure, the lithium-containing transition metal oxide has Li, Mn, and an element M in a lithium-containing transition metal layer in the layered structure and represented by the general composition formula Liₓ[Li_{α}(MnₐMb)_{1-α}]O₂, where 0.5<x<1.1, 0.1<α<0.33, 0.67<a<0.97, and 0.03<b<0.33, and M includes at least one or more elements selected from the group consisting of Ni, Mg, Ti, Fe, Sn, Zr, Nb, Mo, W, and Bi.”

Furthermore, JP-A No. 2010-92824 proposes a positive electrode active material for a non-aqueous electrolyte secondary battery, wherein the electric potential P (V) of a lithium-containing layered oxide LiₐN_{ab}M_{c}O_{2±α}(0.5≤a≤1.3, 0≤b≤0.01, 0.90≤c≤1.10, 0≤α≤0.3, and M is at least one element selected from manganese, cobalt, nickel, iron, aluminum, molybdenum, zirconium, or magnesium) belonging to the space group P6₃mc is in the range of 4.8≤P≤5.0 (vs. Li/Li+), a and c represent the molar ratios of lithium and M, respectively, and the ratio of a when c is assumed to be 1.0 is in the range of 0.08≤a≤0.12.

### SUMMARY

A positive electrode active material having at least one type of crystalline structure selected from the group consisting of an O2 structure, a T #2 structure, and an O6 structure tends to have inferior rapid charge and discharge performance because the internal diffusion rate of the lithium ions is slow.

In recent years, improved rapid charge and discharge performance is desired. In relation to a positive electrode active material having at least one type of crystalline structure selected from the group consisting of an O2 structure, a T #2 structure, and an O6 structure, the development of a positive electrode active material for a lithium ion battery is desired with which a battery with superior rapid charge and discharge performance and a large discharge capacity in an electric potential region including a high electric potential region can be obtained.

Thus, it is a problem to be solved by an embodiment of the present disclosure to provide a positive electrode active material for a lithium ion battery with which a battery with superior rapid charge and discharge performance and a large discharge capacity in an electric potential region including a high electric potential region can be obtained.

It is a problem to be solved by another embodiment of the present disclosure to provide a positive electrode material with which a battery with superior rapid charge and discharge performance and a large discharge capacity in an electric potential region including a high electric potential region can be obtained.

It is a problem to be solved by another embodiment of the present disclosure to provide a positive electrode with which a battery with superior rapid charge and discharge performance and a large discharge capacity in an electric potential region including a high electric potential region can be obtained.

It is a problem to be solved by another embodiment of the present disclosure to provide a solid-state battery with superior rapid charge and discharge performance and a large discharge capacity in an electric potential region including a high electric potential region.

It is a problem to be solved by another embodiment of the present disclosure to provide a positive electrode active material for a sodium ion battery with which a battery with superior rapid charge and discharge performance and a large discharge capacity in an electric potential region including a high electric potential region can be obtained.

It is a problem to be solved by another embodiment of the present disclosure to provide a method of producing a positive electrode active material for a lithium ion battery with which a battery with superior rapid charge and discharge performance and a large discharge capacity in an electric potential region including a high electric potential region can be obtained.

It will be noted that “an electric potential region including a high electric potential region” means a region of 2.0 V to 4.8 V.

Means for solving the above problems include the following means.

A first aspect of the present disclosure provides a positive electrode active material for a lithium ion battery, the material including:

a core portion having a crystalline structure with an 03 structure; and

a shell portion that covers the core portion and has at least one type of crystalline structure selected from the group consisting of an O2 structure, a T #2 structure, and an O6 structure.

A second aspect of the present disclosure provides the positive electrode active material for a lithium ion battery of the first aspect, wherein a diameter R1 of the core portion and a diameter R2 of the positive electrode active material satisfy the following Formula A and Formula B:

$$( R 2 - R 1 ) / 2 \geq 10 nm \qquad Formula A$$

$$( R 2 - R 1 ) / R 2 \geq 0 \text{.01} . \qquad Formula B$$

A third aspect of the present disclosure provides a positive electrode material, the material including the positive electrode active material for a lithium ion battery of the first or second aspect.

A fourth aspect of the present disclosure provides a positive electrode including the positive electrode material of the third aspect.

A fifth aspect of the present disclosure provides a solid-state battery including the positive electrode active material for a lithium ion battery of the first or second aspect.

A sixth aspect of the present disclosure provides a positive electrode active material for a sodium ion battery, the material including:

a core portion having a crystalline structure with an O3 structure; and

a shell portion that covers the core portion and has a crystalline structure with a P2 structure.

A seventh aspect of the present disclosure provides a method of producing a positive electrode active material for a lithium ion battery, the method including a step of elevating the temperature of an Na-containing transition metal oxide having a crystalline structure with an O3 structure to 800° C. or higher and holding the Na-containing transition metal oxide at the elevated temperature for a time t that satisfies The following Formula C:

0.04×t/r2<0.1 Formula C

wherein, in Formula C, t represents time expressed in minutes, and r2 represents a median value, expressed in nm, of a diameter R2 of the positive electrode active material for a lithium ion battery to be obtained).

An eighth aspect of the present disclosure provides the method of producing a positive electrode active material for a lithium ion battery of the seventh aspect, wherein the elevating the temperature and the holding are performed by irradiation with a laser.

According to an embodiment of the present disclosure, there can be provided a positive electrode active material for a lithium ion battery with which a battery with superior rapid charge and discharge performance and a large discharge capacity in an electric potential region including a high electric potential region can be obtained.

According to another embodiment of the present disclosure, there can be provided a positive electrode material with which a battery with superior rapid charge and discharge performance and a large discharge capacity in an electric potential region including a high electric potential region can be obtained.

According to another embodiment of the present disclosure, there can be provided a positive electrode with which a battery with superior rapid charge and discharge performance and a large discharge capacity in an electric potential region including a high electric potential region can be obtained.

According to another embodiment of the present disclosure, there can be provided a solid-state battery with superior rapid charge and discharge performance and a large discharge capacity in an electric potential region including a high electric potential region.

According to another embodiment of the present disclosure, there can be provided a positive electrode active material for a sodium ion battery with which a battery with superior rapid charge and discharge performance and a large discharge capacity in an electric potential region including a high electric potential region can be obtained.

According to another embodiment of the present disclosure, there can be provided a method of producing a positive electrode active material for a lithium ion battery with which a battery with superior rapid charge and discharge performance and a large discharge capacity in an electric potential region including a high electric potential region can be obtained.

### BRIEF DESCRIPTION OF THE DRAWING

FIG. 1 is a schematic sectional view showing an example of a solid-state battery.

### DETAILED DESCRIPTION

Exemplary embodiments of the present disclosure will be described below. The description and Examples are merely illustrative of the embodiments and are not intended to limit the scope of the invention.

When numerical ranges are given gradationally in the present specification, the upper limit value or the lower limit value given for one numerical range may be replaced with the upper limit value or the lower limit value of another gradationally given numerical range. Furthermore, when numerical ranges are given in the present specification, the upper limit values or the lower limit values of those numerical ranges may be replaced with values described in the Examples.

Reference to a particular component in the present specification may encompass a case in which there are two or more substances that correspond to the component.

When plural substances corresponding to a particular component are present in a composition, the amount of the component in a composition indicated in the present specification refers to the total amount of the plural substances present in the composition unless otherwise specified.

The term “step” includes not only an independent step but also a step that is not clearly distinct from other steps, as long as the desired actions of the step of interest is achieved.

### Positive Electrode Active Material for Lithium Ion Battery

The positive electrode active material for a lithium ion battery according to the present disclosure includes: a core portion having a crystalline structure with an O3 structure; and a shell portion that covers the core portion and has at least one type of crystalline structure selected from the group consisting of an O2 structure, a T #2 structure, and an O6 structure.

The positive electrode active material for a lithium ion battery according to the present disclosure, by virtue of having the above configuration, is a positive electrode active material for a lithium ion battery with which a battery with superior rapid charge and discharge performance and a large discharge capacity in an electric potential region including a high electric potential region can be obtained. We surmise that the reasons therefor are as follows.

The positive electrode active material for a lithium ion battery according to the present disclosure includes a shell portion having at least one type of crystalline structure selected from the group consisting of an O2 structure, a T #2 structure, and an O6 structure. For that reason, it has a large charge/discharge capacity when it is charged/discharged in an electric potential region including a high electric potential region.

Additionally, the positive electrode active material for a lithium ion battery according to the present disclosure includes a core portion having a crystalline structure with an O3 structure. A crystalline structure with an O3 structure is advantageous to improving rapid charge and discharge performance because the internal diffusion rate of the lithium ions is high.

We surmise that, because of the above, the positive electrode active material for a lithium ion battery according to the present disclosure is a positive electrode active material for a lithium ion battery with which a battery with superior rapid charge and discharge performance and a large discharge capacity in an electric potential region including a high electric potential region can be obtained.

### Core Portion

The core portion has a crystalline structure with an O3 structure.

Here, a crystalline structure with an O3 structure is a crystalline structure that belongs to the space group R-3m and in which lithium and a transition metal are present in the centers of oxygen octahedrons and there are three ways of stacking of oxygen and the transition metal in a unit lattice. It is preferred that the crystalline structure be a crystalline structure in which one period is formed by six layers of oxygen, three layers of Li, and three layers of the transition metal.

### Shell Portion

The shell portion covers the core portion and has at least one type of crystalline structure selected from the group consisting of an O2 structure, a T #2 structure, and an O6 structure.

Here, a crystalline structure with an O2 structure is a crystalline structure that belongs to the space group P63mc and in which lithium and a transition metal are present in the centers of oxygen octahedrons and there are two ways of stacking of oxygen and the transition metal in a unit lattice. It is preferred that the crystalline structure be a crystalline structure in which one period is formed by four layers of oxygen, two layers of Li, and two layers of the transition metal.

A crystalline structure with a T #2 structure is a crystalline structure that belongs to the space group Cmca and in which lithium is present in the center of an oxygen tetrahedron, a transition metal is present in the center of an oxygen octahedron, and there are two ways of stacking of oxygen and the transition metal in a unit lattice. It is preferred that the crystalline structure be a crystalline structure in which one period is formed by four layers of oxygen, two layers of Li, and two layers of the transition metal.

A crystalline structure with an O6 structure is a crystalline structure that belongs to the space group R-3m and in which lithium and a transition metal are present in the centers of oxygen octahedrons and there are six ways of stacking of oxygen and the transition metal in a unit lattice. It is preferred that the crystalline structure be a crystalline structure in which one period is formed by twelve layers of oxygen, six layers of Me, and six layers of Li.

### Composition Formula of Positive Electrode Active Material for Lithium Ion Battery

As for the composition of the positive electrode active material for a lithium ion battery according to the present disclosure, the core portion and the shell portion may have different compositions or may have the same composition. From the standpoint of rapid charge and discharge performance and discharge capacity, it is preferred that the core portion and the shell portion have the same composition.

From the standpoint of rapid charge and discharge performance and discharge capacity, it is preferred that the positive electrode active material for a lithium ion battery according to the present disclosure be a compound represented by Formula 1 below.

$${Li}_{a} {Na}_{b} {Mn}_{x - p} {Ni}_{y - q} {Co}_{z - r} {M}_{p + q + r} {O}_{2} \qquad Formula 1$$

In Formula 1 above, a, b, x, y, z, p, q, and r are numbers satisfying 0≤a≤1 (preferably 0.6≤a≤1), 0≤b≤0.05 (preferably 0≤b≤0.01), x+y+z=1, and 0<p+q+r≤0.20 (preferably 0≤p+q+r≤0.10), and M represents at least one selected from the group consisting of B, Mg, Al, K, Ca, Ti, Cr, Ga, Zr, Nb, Mo, and W.

It is preferred that M represents at least one selected from the group consisting of B, Mg, Al, K, Ca, Ti, Cr, Ga, Zr, Nb, Mo, and W, and it is more preferred that M represents Al.

x is preferably a number that satisfies 0≤x≤1 and more preferably a number that satisfies 0.1≤x≤1.

y is preferably a number that satisfies 0≤y≤0.5 and more preferably a number that satisfies 0≤y≤0.33.

z is preferably a number that satisfies 0≤z≤1 and more preferably a number that satisfies 0≤z≤0.67.

p is preferably a number that satisfies 0≤p≤0.10.

q is preferably a number that satisfies 0≤q≤0.10.

r is preferably a number that satisfies 0≤r≤0.10.

Specific examples of the composition formula of the positive electrode active material for a lithium ion battery according to the present disclosure include Li_{0.70}Na_{0.00}Mn_{0.50}Ni_{0.20}Co_{0.30}O₂, Li_{0.60}Na_{0.00}Mn_{0.50}Ni_{0.20}Co_{0.30}O₂, Li_{1.0}Na_{0.00}Mn_{0.50}Ni_{0.20}Co_{0.30}O₂, Li_{0.70}Na_{0.05}Mn_{0.50}Ni_{0.20}Co_{0.30}O₂, Li_{0.7}Na_{0.00}Mn_{0.67}Ni_{0.33}O₂, and Li_{0.70}Na_{0.00}Mn_{0.50}Ni_{0.20}Co_{0.20}Al_{0.10}O₂.

(Diameter R1 of Core Portion and Diameter R2 of Positive Electrode Active Material for Lithium Ion Battery)

From the standpoint of rapid charge and discharge performance and discharge capacity, in the positive electrode active material for a lithium ion battery according to the present disclosure, a diameter R1 of the core portion and a diameter R2 of the positive electrode active material for a lithium ion battery preferably satisfy the the following Formula A and Formula B, more preferably satisfy Formula A2 and Formula B2 below, and even more preferably satisfy Formula A3 and Formula B3 below.

$$( R 2 - R 1 ) / 2 \geq 10 nm \qquad Formula A$$

$$( R 2 - R 1 ) / R 2 \geq 0.01 \qquad Formula B$$

$$( R 2 - R 1 ) / 2 \geq 30 nm \qquad Formula A 2$$

$$( R 2 - R 1 ) / R 2 \geq 0.05 \qquad Formula B 2$$

$$( R 2 - R 1 ) / 2 \geq 40 nm \qquad Formula A 3$$

$$( R 2 - R 1 ) / R 2 \geq 0.06 \qquad Formula B 3$$

· Procedure for Measuring Diameter R1 of Core Portion and Diameter R2 of Positive Electrode Active Material for Lithium Ion Battery

The diameter R1 of the core portion and the diameter R2 of the positive electrode active material for a lithium ion battery are measured using a transmission electron microscope. A measurement procedure will be described below with respect to a case in which the shell portion has an O2 crystal structure.

Using a transmission electron microscope, the positive electrode active material for a lithium ion battery is observed by annular bright field scanning transmission electron microscopy (ABF-STEM) at an acceleration voltage of 200 kV or higher and a resolution of 0.2 nm or lower. Then, the interface between a region at which a structure consistent with the space group R-3m is observed and a region at which a structure consistent with the space group P63mc is observed is taken as the interface between the core portion and the shell portion (hereinafter this interface will be called “the core-shell interface”). In a case in which, between the region at which a structure consistent with the space group R-3m is observed and the region at which a structure consistent with the space group P63mc is observed, there is a region at which a structure that is not consistent with either space group is observed, the midpoint of that region is taken as the core-shell interface.

The longest distance from the core-shell interface to the core-shell interface in the region at which a structure consistent with the space group R-3m is observed is taken as the diameter R1 of the core portion.

Furthermore, the distance of a longest line segment interconnecting any two points in the region at which a structure consistent with the space group P63mc is observed is taken as the diameter R2 of the positive electrode active material for a lithium ion battery. In a case in which the shell portion has a T #2 or O6 crystal structure, the above procedure can be applied while replacing the “space group P63mc” with “space group Cmca” or “space group R-3m (O6-type)”.

Here, the measurement orientation of the diameter R1 of the core portion and the diameter R2 of the positive electrode active material for a lithium ion battery is decided as follows.

With respect to planes (e.g., <100>, <010>, <110>, and the like) perpendicular to the crystal lattice (001), the diameters R2 of the positive electrode active material for a lithium ion battery are measured by the above procedure in directions respectively perpendicular to those planes, and the measurement orientation is decided as the orientation that provides the largest value among the measured diameters. Furthermore, the diameter R1 of the core portion is measured by the above procedure so as to share the axis with the diameter R2 of the positive electrode active material for a lithium ion battery.

Regarding the direction parallel to (001), it suffices for (diameter R2 of the positive electrode active material for a lithium ion battery—diameter R1 of the core portion)>0.

From the standpoint of rapid charge and discharge performance and discharge capacity, the diameter R1 of the core portion is preferably from 10 nm to 3000 nm, more preferably from 20 nm to 2000 nm, and even more preferably from 20 nm to 1000 nm.

From the standpoint of rapid charge and discharge performance and discharge capacity, the diameter R2 of the positive electrode active material for a lithium ion battery is preferably from 30 nm to 3600 nm, more preferably from 40 nm to 2400 nm, and even more preferably from 40 nm to 1200 nm.

### Method of Producing Positive Electrode Active Material for Lithium Ion Battery

The method of producing a positive electrode active material for a lithium ion battery according to the present disclosure includes a step (shell forming step) of elevating the temperature of an Na-containing transition metal oxide having a crystalline structure with an O3 structure to 800° C. or higher and holding the Na-containing transition metal oxide at the elevated temperature for a time t that satisfies the following Formula C.

$$0.04 \times t / r 2 < 0.1 \qquad Formula C$$

In Formula C, t represents time expressed in minutes. In Formula C, r2 represents a median value, expressed in nm, of the diameter R2 of the positive electrode active material for a lithium ion battery to be obtained.

### Step of Preparing Na-Containing Transition Metal Oxide

The method for producing a positive electrode active material for a lithium ion battery according to the present disclosure preferably includes a step (step of preparing Na-containing transition metal oxide) of preparing an Na-containing transition metal oxide having a crystalline structure with an O3 structure before the shell forming step.

Specific examples of Na-containing transition metal oxides having a crystalline structure with an O3 structure include Na_{0.75}Mn_{0.5}Ni_{0.2}Co_{0.3}O₂, Na_{0.65}Mn_{0.5}Ni_{0.2}Co_{0.3}O₂, Na_{0.75}Mn_{0.67}Ni_{0.33}O₂, Na_{0.}75Mn_{0.50}Ni_{0.20}Co_{0.20}Al_{0.10}O₂, Na_{0.75}Mn_{0.40}Ni_{0.20}Co_{0.30}Cr_{0.10}O₂, and Na_{0.75}Mn_{0.50}Ni_{0.10}Co_{0.30}Mg_{0.20}O₂.

The Na-containing transition metal oxide having a crystalline structure with an O3 structure is preferably obtained by using as a raw material salts including the metals for configuring the Na-containing transition metal oxide and mixing and reacting these salts.

Examples of the salts include sodium-containing carbonates, manganese-containing nitrates, nickel-containing nitrates, cobalt-containing nitrates, manganese-containing sulfates, nickel-containing sulfates, cobalt-containing sulfates, manganese-containing oxalates, nickel-containing oxalates, cobalt-containing oxalates, sodium-containing hydroxides, and sodium-containing hydrogen carbonates.

### Shell Forming Step

The shell forming step is a step of elevating the temperature of an Na-containing transition metal oxide having a crystalline structure with an O3 structure to 800° C. or higher and holding the Na-containing transition metal oxide at the elevated temperature (hereinafter this temperature will be called a “holding temperature”) for a time t that satisfies the following Formula C.

$$0.04 \times t / r 2 < 0.1 \qquad Formula C$$

In formula C, t represents time expressed in minutes. In Formula C, r2 represents a median value, expressed in nm, of the diameter R2 of the positive electrode active material for a lithium ion battery to be obtained.

Because of this step, there is obtained an Na-containing transition metal oxide including a core portion that has a crystalline structure with an O3 structure and a shell portion that covers the core portion and has a crystalline structure with a P2 structure (the Na-containing transition metal oxide will also be called an “Na-doped precursor” below).

In Formula C, r2 represents a median value of the diameter R2 of the positive electrode active material for a lithium ion battery obtained by the method of producing a positive electrode active material for a lithium ion battery according to the present disclosure.

The median value of the diameter R2 refers to the n/2th R2 value when R2 values measured in regard to n-number of particles are rearranged in ascending order. However, when n is an even number, it refers to the average value of the (n/2)th R2 value and the {(n/2)+1}th R2 value.

The temperature elevation rate of the Na-containing transition metal oxide having a crystalline structure with an O3 structure is preferably from 50° C./min to 200° C./min, more preferably from 80° C./min to 150° C./min, and even more preferably from 90° C./min to 110° C./min.

The holding temperature is preferably from 800° C. to 1100° C., more preferably from 850° C. to 1050° C., and even more preferably from 900° C. to 1000° C.

The time (holding time) t at the holding temperature is preferably 2 minutes to 10 minutes, more preferably 3 minutes to 8 minutes, and even more preferably 4 minutes to 6 minutes.

It is preferred that the Na-doped precursor be cooled after holding it at the holding temperature. The cooling rate at this time is preferably from 50° C./min to 200° C./min, more preferably from 80° C./min to 150° C./min, and even more preferably from 90° C./min to 110° C./min.

Here, the measurement of the temperature of the Na-containing transition metal oxide having a crystalline structure with an O3 structure and the Na-doped precursor in this step is performed using a thermometer.

As the thermometer, for example, a thermometer in which a platinum Rh-based R-type thermocouple is connected to the temperature indicator SK-EM-01 made by Sato Keiryoki Mfg. Co., Ltd. can be used.

The shell forming step is not particularly limited as long as the Na-containing transition metal oxide having a crystalline structure with an O3 structure can be heated under the above conditions, but from the standpoint of being able to form the shell portion easily, it is preferred that the shell forming step be performed by irradiation with a laser.

When the shell forming step is performed by irradiation with a laser, for example, it is preferred that the Na-containing transition metal oxide having a crystalline structure with an O3 structure be irradiated with a laser from a laser emitter to thereby heat the Na-containing transition metal oxide having a crystalline structure with an O3 structure.

The wavelength of the laser light that is emitted can range from 300 nm to 1000 nm.

As the laser emitter, any emitter equipped with a semiconductor laser light source can be appropriately selected; for example, the product ExLASER made by SAKAGUCHI Electric Heaters Co. Ltd. can be used.

### Ion Exchange Step

The method of producing a positive electrode active material for a lithium ion battery according to the present disclosure preferably includes a step of ion-exchanging Na included in the Na-doped precursor with Li.

For the ion exchange of the Na-doped precursor, a molten salt bed in which lithium nitrate and lithium chloride are mixed can be used.

The temperature conditions during ion exchange are preferably in a range equal to or higher than the temperature at which the molten salt bed melts but less than 320° C.

### Positive Electrode Active Material for Sodium Ion Battery

The positive electrode active material for a sodium ion battery according to the present disclosure includes a core portion having a crystalline structure with an O3 structure and a shell portion that covers the core portion and has a crystalline structure with a P2 structure.

Here, the positive electrode active material for a sodium ion battery according to the present disclosure can be used as the Na-doped precursor in the method of producing a positive electrode active material for a lithium ion battery according to the present disclosure.

It is preferred that the positive electrode active material for a sodium ion battery according to the present disclosure be produced via the step of preparing the Na-containing transition metal oxide and the shell forming step in the method of producing a positive electrode active material for a lithium ion battery described above.

The core portion and the shell portion in the positive electrode active material for a sodium ion battery are distinguished using a transmission electron microscope. A method of distinguishing the core portion and the shell portion will be described below.

Using a transmission electron microscope, the positive electrode active material for a lithium ion battery is observed by annular bright field scanning transmission electron microscopy (ABF-STEM) at an acceleration voltage of 200 kV or higher and a resolution of 0.2 nm or lower. Then, the interface between a region at which a structure consistent with the space group R-3m is observed and a region at which a structure consistent with the space group P63/mmc is observed is taken as the interface between the core portion and the shell portion (hereinafter this interface will be called “the core-shell interface”). In a case in which, between the region at which a structure consistent with the space group R-3m is observed and the region at which a structure consistent with the space group P63/mmc is observed, there is a region at which a structure that is not consistent with either space group is observed, the midpoint of that region is taken as the core-shell interface.

Specific examples of the positive electrode active material for a sodium ion battery according to the present disclosure include Na_{0.75}Mn_{0.5}Ni_{0.2}Co_{0.3}O₂, Na_{0.65}Mn_{0.5}Ni_{0.2}Co_{0.3}O₂, Na_{0.75}Mn_{0.67}Ni_{0.33}O₂, Na_{0.75}Mn_{0.50}Ni_{0.20}Co_{0.20}Al_{0.10}O₂, Na_{0.75}Mn_{0.40}Ni_{0.20}Co_{0.30}Cr_{0.10}O₂, and Na_{0.75}Mn_{0.50}Ni_{0.10}Co_{0.30}Mg_{0.20}O₂.

The positive electrode material according to the present disclosure contains a positive electrode active material for a lithium ion battery and may also contain a conductive additive, a solid electrolyte, a binder, and other components as needed.

### Positive Electrode Active Material for Lithium Ion Battery

As the positive electrode active material for a lithium ion battery included in the positive electrode material according to the present disclosure, the positive electrode active material for a lithium ion battery according to the present disclosure is applied, and preferred aspects thereof are also the same.

The positive electrode active material for a lithium ion battery included in the positive electrode material according to the present disclosure may also contain another positive electrode active material for a lithium ion battery other than the positive electrode active material for a lithium ion battery according to the present disclosure.

The other positive electrode active material for a lithium ion battery preferably includes a lithium complex oxide. The lithium complex oxide may contain at least one selected from the group consisting of F, Cl, N, S, Br, and I. Furthermore, the lithium complex oxide may have a crystalline structure belonging to at least one space group selected from the space groups R-3m, Immm, and P63-mmc (also called P63mc and P6/mmc). Furthermore, the main array of the transition metal, oxygen, and lithium in the lithium complex oxide may have an O2 structure.

Examples of lithium complex oxides having a crystalline structure belonging to R-3m include compounds represented by LiₓMe_{y}O_{α}X_{β} (where Me represents at least one selected from the group consisting of Mn, Co, Ni, Fe, Al, Cu, V, Nb, Mo, Ti, Cr, Zr, Zn, Na, K, Ca, Mg, Pt, Au, Ag, Ru, W, B, Si, and P, X represents at least one selected from the group consisting of F, Cl, N, S, Br, and I, and x, y, α, and β satisfy 0.5≤x≤1.5, 0.5≤y≤1.0, 1≤α<2, and 0<β≤1).

Examples of lithium complex oxides having a crystalline structure belonging to Immm include complex oxides represented by Liₓ₁M¹A¹₂ (in which x1 satisfies 1.5≤x1≤2.3, M¹ includes at least one selected from the group consisting of Ni, Co, Mn, Cu, and Fe, and A¹ includes at least oxygen, and the proportion of oxygen in A¹ is 85 at % or more) (a specific example is Li₂NiO₂) and complex oxides represented by Liₓ₁M^{1A}₁₋ₓ₂M^{1B}ₓ₂O_{2-y}A²_{y} (in which 0≤x2≤0.5 and 0≤y≤0.3 and at least one of x2 or y is not 0, M^{1A} represents at least one selected from the group consisting of Ni, Co, Mn, Cu, and Fe, M^{1B} represents at least one selected from the group consisting of Al, Mg, Sc, Ti, Cr, V, Zn, Ga, Zr, Mo, Nb, Ta, and W, and A2 represents at least one selected from the group consisting of F, Cl, Br, S, and P).

Examples of lithium complex oxides having a crystalline structure belonging to P63-mmc include complex oxides represented by M1ₓM2_{y}O₂ (in which M1 represents an alkali metal (preferably at least one of Na or K), M2 represents a transition metal (preferably at least one selected from the group consisting of Mn, Ni, Co, and Fe), and x+y satisfies 0<x+y≤2).

Examples of lithium complex oxides having a crystalline structure with an O2 structure include complex oxides represented by Liₓ[Li_{α}(MnₐCO_{b}M_{c})_{1-α}]O₂ (where 0.5<x<1.1, 0.1<α<0.33, 0.17<a<0.93, 0.03<b<0.50, 0.04<c<0.33, and M represents at least one selected from the group consisting of Ni, Mg, Ti, Fe, Sn, Zr, Nb, Mo, W, and Bi), and specific examples thereof include Li_{0.744}[Li_{0.145}Mn_{0.625}Co_{0.115}Ni_{0.115}]O₂.

In a more preferred aspect, at least part of the surface of the other positive electrode active material is coated with a sulfide solid electrolyte, an oxide solid electrolyte, or a halide solid electrolyte. As the halide solid electrolyte for coating at least part of the surface of the positive electrode active material, Li_{6-(4-x)b}(Ti₁₋ₓAlₓ)_{b}F₆ (0<x<1 and 0<b≤1.5) [LTAF electrolyte] is preferred.

### Conductive Additive

Examples of conductive additives include carbon materials, metal materials, and conductive polymer materials. Examples of carbon materials include carbon black (e.g., acetylene black, furnace black, Ketjen black), fibrous carbon (e.g., vapor-grown carbon fibers, carbon nanotubes, carbon nanofibers), graphite, and carbon fluoride. Examples of metal materials include metal powders (e.g., aluminum powder), conductive whiskers (e.g., zinc oxide, potassium titanate), and conductive metal oxides (e.g., titanium oxide). Examples of conductive polymer materials include polyaniline, polypyrrole, and polythiophene. Just one conductive additive may be used by itself, or two or more conductive additives may be mixed together and used.

### Solid Electrolyte

It is preferred that the solid electrolyte include at least one solid electrolyte species selected from the solid electrolyte group comprising a sulfide solid electrolyte, an oxide solid electrolyte, and a halide solid electrolyte.

The sulfide solid electrolyte contains sulfur (S) as the main anion element and also, for example, preferably contains an Li element and an A element. The A element is at least one selected from the group consisting of P, As, Sb, Si, Ge, Sn, B, Al, Ga, and In. The sulfide solid electrolyte may further contain at least one of O or a halogen element. Examples of the halogen element (X) include F, Cl, Br, and I. The composition of the sulfide solid electrolyte is not particularly limited, and examples include xLi₂S·(100−x)P₂S₅ (70≤x≤80) and yLiI·zLiBr·(100−y−z)(xLi₂S·(1−x)P₂S₅) (0.7≤x≤0.8, 0≤y≤30, 0≤z≤30). The sulfide solid electrolyte may have the composition represented by General Formula (1) below.

$${Li}_{4 - x} {Ge}_{1 - x} {P}_{x} {S}_{4} ( 0 < x < 1 ) \qquad Formula ( 1 )$$

In Formula (1), at least part of Ge may be substituted with at least one selected from the group consisting of Sb, Si, Sn, B, Al, Ga, In, Ti, Zr, V, and Nb. Furthermore, at least part of P may be substituted with at least one selected from the group consisting of Sb, Si, Sn, B, Al, Ga, In, Ti, Zr, V, and Nb. Part of Li may be substituted with at least one selected from the group consisting of Na, K, Mg, Ca, and Zn. Part of S may be substituted with a halogen. The halogen may be at least one of F, Cl, Br, or I.

The oxide solid electrolyte contains oxygen (O) as the main anion element, and may contain an Li element and a Q element (Q representing at least one of Nb, B, Al, Si, P, Ti, Zr, Mo, W, or S). Examples of oxide solid electrolytes include garnet-type solid electrolytes, perovskite-type solid electrolytes, NASICON-type solid electrolytes, Li—P—O-based solid electrolytes, and Li—B—O-based solid electrolytes. Example of garnet-type solid electrolytes include Li₇La₃Zr₂O₁₂, Li₇₋ₓLa₃(Zr₂₋ₓNbₓ)O₁₂ (0≤x≤2), and Li₅La₃Nb₂O₁₂. Examples of perovskite-type solid electrolytes include (Li, La)TiO₃, (Li, La)NbO₃, and (Li, Sr)(Ta, Zr)O₃. Examples of NASICON-type solid electrolytes include Li(Al, Ti)(PO₄)₃ and Li(Al, Ga)(PO₄)₃. Examples of Li—P—O-based solid electrolytes include Li₃PO₄ and LIPON (a compound in which part of O in Li₃PO+is substituted with N), and examples of Li—B—O-based solid electrolytes include Li₃BO₃ and compounds obtained by substituting part of O in Li₃BO₃ with C.

As the halide solid electrolyte, a solid electrolyte including Li, M, and X (M representing at least one of Ti, Al, or Y, and X representing F, Cl, or Br) is preferred. Specifically, Li_{6-3z} Y_{z}X₆ (in which X represents Cl or Br, and z satisfies 0<z<2) and Li_{6-(4-x)b}(Ti₁₋ₓAlₓ)_{b}F₆ (0<x<1, 0<b≤1.5) are preferred. Among Li_{6-3z}Y_{z}X₆, in terms of having superior lithium ion conductivity, Li₃YX₆ (in which X represents Cl or Br) is more preferred, and Li₃ YCl₆ is even more preferred. Furthermore, it is preferred that Li_{6-(4-x)b}(Ti₁₋ₓAlₓ)_{b}F₆ (0<x<1, 0<b≤1.5) be included together with a solid electrolyte such as a sulfide solid electrolyte from the standpoint of inhibiting oxidative decomposition of the sulfide solid electrolyte.

### Binder

Examples of binders include vinyl halide resins, rubbers, and polyolefin resins. Examples of vinyl halide resins include polyvinylidene fluoride (PVdF) and a copolymer of polyvinylidene fluoride and hexafluoropropylene (PVdF-HFP). Examples of polyolefin resins include butadiene rubber (BR), acrylate-butadiene rubber (ABR), styrene-butadiene rubber (SBR), acrylonitrile-butadiene rubber (NBR), and butyl rubber (isobutylene-isoprene rubber). Examples of polyolefin resins include polyethylene and polypropylene. The binder may be a diene-based rubber including a double bond in its main chain, such as a butadiene-based rubber in which butadiene occupies 30 mol % or more of the entire rubber.

### Other Components

Examples of other components include oxide solid electrolytes, halide solid electrolytes, thickeners, surfactants, dispersants, wetting agents, antifoaming agents, and solvents.

### Solid-State Battery

The solid-state battery according to the present disclosure includes the positive electrode active material for a lithium ion battery according to the present disclosure.

The solid-state battery according to the present disclosure preferably includes a positive electrode layer, a negative electrode layer, and an electrolyte layer or a separator disposed between the positive electrode layer and the negative electrode layer. Additionally, the positive electrode layer preferably includes the positive electrode material of the present disclosure.

### Battery Structure

The solid-state battery includes what is called an all-solid-state battery which uses an inorganic solid electrolyte as the electrolyte (in which the content of the electrolyte solution serving as an electrolyte is less than 10% by mass relative to the total amount of electrolytes).

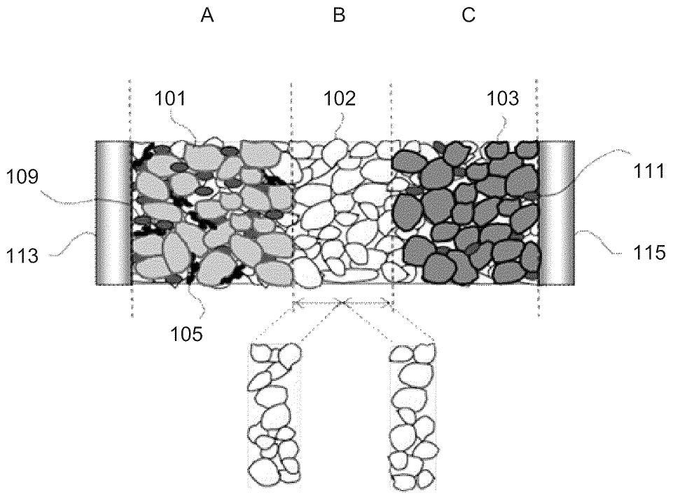

FIG. 1 is a schematic sectional view showing an example of the solid-state battery of the present disclosure. The solid-state battery shown in FIG. 1 includes a negative electrode, which includes a negative electrode current collector 113 and a negative electrode layer A, a solid electrolyte layer B, and a positive electrode, which includes a positive electrode current collector 115 and a positive electrode layer C. The negative electrode layer A includes a negative electrode active material 101, a conductive additive 105, a binder 109, and a solid electrolyte 102. The positive electrode layer C includes a positive electrode active material 103, a binder 111, and the solid electrolyte 102.

When a set of the positive electrode layer, the solid electrolyte layer, and the negative electrode layer serves as a power generation unit, the solid-state battery may have just one power generation unit or may have two or more power generation units. When the solid-state battery has two or more power generation units, those power generation units may be connected in series or in parallel.

The solid-state battery may be configured by sealing, with resin, stack edge faces (side faces) of a stacked structure of the positive electrode layer/the solid electrolyte layer/the negative electrode layer. The current collectors of the electrodes may have a configuration in which a buffer layer, an elastic layer, or a positive temperature coefficient (PTC) thermistor layer is disposed on the surface.

The shape of the solid-state battery is not particularly limited and, for example, may be coin-shaped, cylindrical, rectangular, sheet-shaped, button-shaped, flat-shaped, or stacked.

### Electrolyte Layer and Separator

The solid-state battery includes an electrolyte layer or a separator. The electrolyte layer may be a layer including a solid electrolyte.

When the electrolyte layer is a layer including a solid electrolyte (a solid electrolyte layer), the solid electrolyte layer preferably includes one selected from the group consisting of a sulfide solid electrolyte, an oxide solid electrolyte, and a halide solid electrolyte.

As specific examples of the sulfide solid electrolyte, the oxide solid electrolyte, and the halide solid electrolyte, the same ones as those described above are applied.

The solid electrolyte layer may have a single-layer structure or a multi-layer structure including two or more layers.

The solid electrolyte layer may or may not include a binder. As examples of the binder that can be included in the solid electrolyte layer, the same binders as those described above are applied.

As the separator, a porous sheet (film) formed from a resin such as polyethylene (PE), polypropylene (PP), polyester, cellulose, or polyamide can be used.

### Positive Electrode Layer

The solid-state battery includes a positive electrode layer. The positive electrode layer includes the positive electrode material of the present disclosure.

### Positive Electrode Current Collector

The solid-state battery may further include a positive electrode current collector. The positive electrode current collector collects current for the positive electrode layer. The positive electrode current collector is disposed at a position at a side opposite to the electrolyte layer (or the separator) in relation to the positive electrode layer.

Examples of positive electrode current collectors include stainless steel, aluminum, copper, nickel, iron, titanium, and carbon, with aluminum alloy foil or aluminum foil being preferred. Aluminum alloy foil and aluminum foil may be produced using powder. The shape of the positive electrode current collector is, for example, foil-shape or mesh-shape.

The positive electrode current collector may have a configuration in which a buffer layer, an elastic layer, or a positive temperature coefficient (PTC) thermistor layer is disposed on the surface.

### Negative Electrode Layer

The solid-state battery includes a negative electrode layer. The negative electrode layer contains a negative electrode active material. The negative electrode layer may contain at least one of a solid electrolyte for a negative electrode, a conductive additive, or a binder as needed. Examples of negative electrode active materials include Li-based active materials such as metallic lithium, carbon-based active materials such as graphite, oxide-based active materials such as lithium titanate, and Si-based active materials such as simple Si. Examples of the conductive additive, the solid electrolyte for a negative electrode, and the binder used in the negative electrode layer include the same ones as those given for the conductive additive included in the positive electrode layer, the solid electrolyte included in the solid electrolyte layer, and the binder.

### Negative Electrode Current Collector

The solid-state battery may further include a negative electrode current collector. The negative electrode current collector collects current for the negative electrode layer. The negative electrode current collector is disposed at a position at a side opposite to the electrolyte layer (or the separator) in relation to the negative electrode layer.

Examples of negative electrode current collectors include stainless steel, aluminum, copper, nickel, iron, titanium, and carbon, with copper being preferred. The shape of the negative electrode current collector is, for example, foil-shape or mesh-shape.

The negative electrode current collector may have a configuration in which a buffer layer, an elastic layer, or a positive temperature coefficient (PTC) thermistor layer is disposed on the surface.

### Positive Electrode and Negative Electrode

The solid-state battery according to the present disclosure includes a positive electrode. The positive electrode may include the positive electrode layer and the positive electrode current collector described above or may be configured by just the positive electrode layer. From the standpoint of rapid charge and discharge performance and discharge capacity, it is preferred that the positive electrode include the positive electrode material according to the present disclosure.

The solid-state battery according to the present disclosure includes a negative electrode. The negative electrode may include the negative electrode layer and the negative electrode current collector described above or may be configured by just the negative electrode layer.

### Method of Producing Solid-State Battery

The method of producing a solid-state battery according to the present disclosure includes: a step (preparation step) of preparing a positive electrode layer, a negative electrode layer, and an electrolyte layer or a separator; and a step (stacking step) of stacking the positive electrode layer, the electrolyte layer or the separator, and the negative electrode layer in this order.

### Preparation Step

The preparation step is a step of preparing a positive electrode layer, a negative electrode layer, and an electrolyte layer or a separator.

The method of preparing the positive electrode layer, the negative electrode layer, and the electrolyte layer is not particularly limited, but it is preferred that they be prepared by kneading the components that can be contained in the positive electrode layer, the negative electrode layer, and the electrolyte layer to obtain a slurry, then applying the slurry to a substrate, drying the slurry to obtain a dry film, and pressing the dry film. The method of kneading the components that can be contained in the positive electrode layer when obtaining the slurry is not particularly limited, and examples thereof include a method of kneading using a kneading device. Examples of kneading devices include ultrasonic homogenizers, shakers, thin-film rotary mixers, dissolvers, homomixers, kneaders, roll mills, sand mills, attritors, ball mills, vibrator mills, and high-speed impeller mills.

Examples of techniques for pressing the dry film include roll pressing and cold isostatic pressing (CIP).

The pressure during pressing is preferably 0.1 t (ton)/cm² or more, more preferably 0.5 t/cm² or more, and even more preferably 1 t/cm² or more. The pressure during pressing is preferably 10 t/cm² or less, more preferably 8 t/cm² or less, and even more preferably 6 t/cm² or less.

As the separator, a commercially available porous sheet (film) can be used.

### Stacking Step

The stacking step is a step of stacking the positive electrode layer, the electrolyte layer or the separator, and the negative electrode in this order.

It is preferred that in the stacking step the positive electrode layer, the electrolyte layer or the separator, and the negative electrode layer that have been prepared in the preparation step be stacked in this order and pressed as needed to obtain a stack (electrode body).

The solid-state battery according to the present disclosure is preferably prepared via the above steps.

### EXAMPLES

Examples will be described below, but the present invention is not in any way limited to these Examples. It will be noted that in the following description, “parts” and “%” are all based on mass unless otherwise specified.

### Example 1

### Production of Positive Electrode Active Material for Lithium Ion Batter

### Step of Preparing Na-containing Transition Metal Oxide

Mn(NO₃)₂·6H₂O, Ni(NO₃)₂·6H₂O, and Co(NO₃)₂·6H₂O were used as raw materials and dissolved in pure water so that the molar ratio of Mn, Ni, and Co was 5:2:3. A Na₂CO₃ solution with a concentration of 12% by mass was prepared, and these two solutions were simultaneously added into a beaker. At this time, the addition rate was controlled so that the pH was 7.0 or more but less than 7.1. After the addition was completed, the mixed solution was stirred for 24 hours at 50° C. and 300 rpm. The obtained reaction product was washed with pure water and centrifuged to separate only the precipitated powder. The obtained powder was dried at 120° C. for 48 hours and then pulverized in an agate mortar to obtain a powder (hereinafter, this powder will be called an “intermediate powder”).

Na₂CO₃ was added to and mixed with the obtained intermediate powder so that the composition ratio was Na_{0.75}Mn_{0.5}Ni_{0.2}Co_{0.3}O₂. The mixed powder was pressed with a load of 2 tons using cold isostatic pressing to prepare pellets. The obtained pellets were pre-fired in the atmosphere at 600° C. for 6 hours and fired at 700° C. for 24 hours, then cooled to room temperature to obtain an Na-containing transition metal oxide having a crystalline structure with an O3 structure (Na_{0.75}Mn_{0.5}Ni_{0.2}Co_{0.3}O₂).

### Shell Forming Step

The Na-containing transition metal oxide having a crystalline structure with an O3 structure was irradiated with a laser using a laser emitter (ExLASER made by SAKAGUCHI Electric Heaters Co. Ltd.) to thereby heat the Na-containing transition metal oxide to 900° C. at a temperature elevation rate of 100° C./min. It was held at a holding temperature of 900° C. for a holding time t of 5 minutes. Thereafter, the Na-containing transition metal oxide was cooled to 250° C. at a cooling rate of 100° C./min and then allowed to cool to room temperature. As a result, an Na-containing transition metal oxide (Na-doped precursor) (Na_{0.75}Mn_{0.5}Ni_{0.2}Co_{0.3}O₂) including a core portion having a crystalline structure with an O3 structure and a shell portion that covers the core portion and has a crystalline structure with a P2 structure was obtained.

### Ion Exchange Step

A mixed powder was obtained by mixing LiNO₃ and LiCI at a mass ratio of 88:12. The mixed powder was weighed so that the ratio of the number of moles of Li included in the mixed powder to the number of moles of the Na-doped precursor was 10 times. The Na-doped precursor and the mixed powder were mixed, and ion exchange was performed in the atmosphere at 280° C. for 1 hour. After ion exchange, water was added to dissolve the salt, and washing with water was further performed to obtain a positive electrode active material 1 for a lithium ion battery (Li_{0.66}Mn_{0.50}Ni_{0.20}Co_{0.30}O₂).

### Production of Solid-State Battery

### Preparation Step

### Preparation of Positive Electrode Layer

85 g of the positive electrode active material 1 for a lithium ion battery (ball-milled to a powder) and 10 g of carbon black as a conductive additive were introduced to 125 mL of a solution of solvent n-methylpyrrolidone in which 5 g of polyvinylidene fluoride (PVDF) as a binder was dissolved, and the mixture was kneaded until uniformly mixed to prepare a slurry. The slurry was applied at a basis weight of 6 mg/cm² to one side of a 15 μm-thick Al positive electrode current collector as a substrate and dried to obtain an electrode. Thereafter, the electrode was pressed so that the thickness of the positive electrode layer was 45 μm and the density of the positive electrode layer was 2.4 g/cm³. Finally, the electrode was cut out to a diameter of 16 mm to obtain a positive electrode having a positive electrode layer and a positive electrode current collector.

### Preparation of Negative Electrode Layer

A negative electrode layer was obtained by cutting out Li foil to a diameter of 19 mm.

### Preparation of Separator

A porous sheet made of PP was prepared as a separator.

### Stacking Step

The positive electrode, the separator, and the negative electrode layer were stacked in this order to obtain a stack. It will be noted that the positive electrode was stacked so that the positive electrode layer faced the separator. The stack and a non-aqueous electrolyte solution (a solution obtained by dissolving lithium hexafluorophosphate (LiPF₆) as a supporting salt at a concentration of 1 mol/L in an ethylene carbonate (EC)/dimethyl carbonate (DMC) mixture with a volume ratio of 3:7) were housed in a coin cell to prepare a CR2032 coin cell battery.

### Example 2

### Production of Positive Electrode Active Material for Lithium Ion Battery

A positive electrode active material for a lithium ion battery was obtained by the same procedure as in Example 1 except that in the “(Shell Forming Step)” the holding time t was changed to 0.5 minute. The positive electrode active material for a lithium ion battery will be used as a positive electrode active material 2 for a lithium ion battery (Li_{0.68}Mn_{0.50}Ni_{0.20}Co_{0.30}O₂).

### Production of Solid-State Battery

A coin cell battery was prepared by the same procedure as in Example 1 except that in the “(Preparation Step)—Preparation of Positive Electrode Layer—” the positive electrode active material 1 for a lithium ion battery was replaced with the positive electrode active material 2 for a lithium ion battery.

### Comparative Example 1

### Production of Positive Electrode Active Material for Lithium Ion Battery

A positive electrode active material for a lithium ion battery was obtained by the same procedure as in Example 1 except that the “Shell Forming Step” was not performed and the “(Ion Exchange Step)” was performed using as the Na-doped precursor an Na-containing transition metal oxide having a crystalline structure with an O3 structure obtained via the “(Step of Preparing Na-containing Transition Metal Oxide)”. The positive electrode active material for a lithium ion battery will be used as a positive electrode active material Cl for a lithium ion battery (Li_{0.70}Na_{0.02}Mn_{0.50}Ni_{0.20}Co_{0.30}O₂).

### Production of Solid-State Battery

A coin cell battery was prepared by the same procedure as in Example 1 except that in the “(Preparation Step)—Preparation of Positive Electrode Layer—” the positive electrode active material 1 for a lithium ion battery was replaced with the positive electrode active material C1 for a lithium ion battery.

### Comparative Example 2

### Production of Positive Electrode Active Material for Lithium Ion Battery

A positive electrode active material for a lithium ion battery was obtained by the same procedure as in Example 1 except that the “(Shell Forming Step)” was changed to the following procedure. The positive electrode active material for a lithium ion battery will be used as a positive electrode active material C2 for a lithium ion battery (Li_{0.68}Mn_{0.50}Ni_{0.20}Co_{0.30}O₂).

### Shell Forming Step

The Na-containing transition metal oxide having a crystalline structure with an O3 structure was irradiated with a laser using a laser emitter to thereby heat the Na-containing transition metal oxide to 900° C. at a temperature elevation rate of 3° C./min. It was held at a holding temperature of 900° C. for a holding time t of 1440 minutes (i.e., 24 hours). Thereafter, the Na-containing transition metal oxide was cooled to 250° C. at a cooling rate of 5° C./min and then left to cool to room temperature. As a result, a Na-doped precursor (Na_{0.75}Mn_{0.5}Ni_{0.2}Co_{0.3}O₂) was obtained.

### Production of Solid-State Battery

A coin cell battery was prepared by the same procedure as in Example 1 except that in the “(Preparation Step)—Preparation of Positive Electrode Layer—” the positive electrode active material 1 for a lithium ion battery was replaced with the positive electrode active material C2 for a lithium ion battery.

### Example 3

A positive electrode active material for a lithium ion battery was obtained by the same procedure as in Example 1 except that in the “(Shell Forming Step)” the holding time t was changed to 0.083 minute (i.e., 5 seconds). The positive electrode active material for a lithium ion battery will be used as a positive electrode active material 3 for a lithium ion battery (Li_{0.69}Mn_{0.50}Ni_{0.20}Co_{0.30}O₂).

### Production of Solid-State Battery

A coin cell battery was prepared by the same procedure as in Example 1 except that in the “(Preparation Step)—Preparation of Positive Electrode Layer—” the positive electrode active material 1 for a lithium ion battery was replaced with the positive electrode active material 3 for a lithium ion battery.

### Comparative Example 3

A positive electrode active material for a lithium ion battery was obtained by the same procedure as in Example 1 except in the “Shell Forming Step” the holding temperature was set at 700° C. and the holding time t was set at 5 minutes. The positive electrode active material for a lithium ion battery will be used as a positive electrode active material C3 for a lithium ion battery (Li_{0.65}Mn_{0.50}Ni_{0.20}Co_{0.30}O₂).

### Production of Solid-State Battery

A coin cell battery was prepared by the same procedure as in Example 1 except that in the “(Preparation Step)—Preparation of Positive Electrode Layer—” the positive electrode active material 1 for a lithium ion battery was changed to the positive electrode active material C3 for a lithium ion battery.

### Evaluation

### R1 and R2

Table 1 shows results obtained by determining, in accordance with the “·Procedure for Measuring Diameter R1 of Core Portion and Diameter R2 of Positive Electrode Active Material for Lithium Ion Battery” described above, the “diameter R1 of the core portion and the diameter R2 of the positive electrode active material for a lithium ion battery” of the positive electrode active material for a lithium ion battery obtained in each example.

### Initial Discharge Capacity

A charge/discharge test was implemented using a galvanostat at a current of 0.1 C, an end-of-charge voltage of 4.8 V, and an end-of-discharge voltage of 2.0 V. Charging was performed first, and after a first charging was completed, the amount of current required for discharging to 2.0 V was calculated, and the initial discharge capacity was calculated by dividing the amount of current by the weight of the active material used for measurement.

### Discharge Capacity at 5 C

A charge/discharge test was implemented using a galvanostat at a current of 5 C, an end-of-charge voltage of 4.8 V, and an end-of-discharge voltage of 2.0 V. Charging was performed first, and after a first charging was completed, the amount of current required for discharging to 2.0 V was calculated, and the discharge capacity at 5 C was calculated by dividing the amount of current by the weight of the active material used for measurement.

### Capacity Retention Rate after 50 Cycles

A charge/discharge test was implemented under the same conditions as those for the initial discharge capacity, and the discharge capacity in the first charge-discharge cycle and the discharge capacity in the fiftieth charge-discharge cycle were calculated. The capacity retention rate after 50 cycles was obtained by dividing the discharge capacity in the fiftieth cycle by the discharge capacity in the first cycle.

TABLE 1

| | | | | | Positive Electrode Active | |
|---|---|---|---|---|---|---|
| | Shell Forming Step | | | | Material for Lithium Ion Battery | |
| | Holding | Holding | | | Structure | Structure |
| | Temperature | Time t | r2 | 0.04 × | of Core | of Shell |
| | (° C.) | (minutes) | (nm) | t/r2 | Portion | Portion |
| Example 1 | 900 | 5 | 1259 | 0.00029 | O3 | O2 |
| Example 2 | 900 | 0.5 | 1714 | 0.00011 | O3 | O2 |
| Comparative | — | — | — | — | O3 | — |
| Example 1 | | | | | | |
| Comparative | 900 | 1440 | — | — | O2 | — |
| Example 2 | | | | | | |
| Example 3 | 900 | 0.083 | 1750 | 0.00009 | O3 | O2 |
| Comparative | 700 | 5 | 1458 | — | O2 | O3 |
| Example 3 | | | | | | |

| | | | | | Evaluation | | |
|---|---|---|---|---|---|---|---|
| | | | | | | | Capacity |
| | Positive Electrode Active | | | | Initial | Discharge | Retention |
| | Material for Lithium Ion Battery | | | | Discharge | Capacity | Rate (%) |
| | Diameter | Diameter | (R2 − | (R2 − | Capacity | (mAh/g) | after 50 |
| | R1 | R2 | R1)/2 | R1)/R2 | (mAh/g) | at 5 C | Cycles |
| Example 1 | 1157 | 1259 | 51 | 0.081 | 211 | 163 | 96 |
| Example 2 | 1690 | 1714 | 12 | 0.014 | 207 | 181 | 95 |
| Comparative | — | — | — | — | 205 | 174 | 71 |
| Example 1 | | | | | | | |
| Comparative | — | — | — | — | 214 | 108 | 97 |
| Example 2 | | | | | | | |
| Example 3 | 1736 | 1750 | 7 | 0.008 | 202 | 176 | 88 |
| Comparative | 1458 | 1458 | 0 | 0 | 215 | 121 | 85 |
| Example 3 | | | | | | | |

In Table 1, a “—” sign appears in columns under “Shell Forming Step” for Comparative Example 1, and this means that the shell forming step was not performed.

In Table 1, there are places where a “—” sign appears in columns under “Positive Electrode Active Material for Lithium Ion Battery” for Comparative Example 1 and Comparative Example 2. This is because in Comparative Example 1 the obtained positive electrode active material for a lithium ion battery had only a crystalline structure with an O3 structure and did not have a core portion and a shell portion. This is also because in Comparative Example 2 the obtained positive electrode active material for a lithium ion battery had only a crystalline structure with an O2 structure and did not have a core portion and a shell portion.

From the above results, it can be seen that with the positive electrode active materials for a lithium ion battery of the Examples, a battery with superior rapid charge and discharge performance and a large discharge capacity in an electric potential region including a high electric potential region can be obtained.

What is claimed is:

1. A positive electrode active material for a lithium ion battery, the material comprising:
a core portion having a crystalline structure with an O3 structure; and
a shell portion that covers the core portion and has at least one type of crystalline structure selected from the group consisting of an O2 structure, a T #2 structure, and an O6 structure.

2. The positive electrode active material for a lithium ion battery according to claim 1, wherein a diameter R1 of the core portion and a diameter R2 of the positive electrode active material satisfy the following Formula A and Formula B:
(R2−R1)/2≥10 nm Formula A
$$( R 2 - R 1 ) / R 2 \geq 0.01 . \qquad Formula B$$

3. A positive electrode material, comprising the positive electrode active material for a lithium ion battery of claim 1.

4. A positive electrode, comprising the positive electrode material of claim 3.

5. A solid-state battery including the positive electrode active material for a lithium ion battery of claim 1.

6. A positive electrode active material for a sodium ion battery, the material comprising:
a core portion having a crystalline structure with an O3 structure; and
a shell portion that covers the core portion and has a crystalline structure with a P2 structure.

7. A method of producing a positive electrode active material for a lithium ion battery, the method comprising elevating the temperature of an Na-containing transition metal oxide having a crystalline structure with an O3 structure to 800° C. or higher, and holding the Na-containing transition metal oxide at the elevated temperature for a time t that satisfies The following Formula C:
$$0.04 \times t / r 2 < 0.1 \qquad Formula C$$
wherein, in Formula C, t represents time expressed in minutes, and r2 represents a median value, expressed in nm, of a diameter R2 of the positive electrode active material for a lithium ion battery to be obtained.

8. The method of producing a positive electrode active material for a lithium ion battery of claim 7, wherein the elevating the temperature and the holding are performed by irradiation with a laser.
